(19) United States
(12) Patent Application Publication
(10) Pub. No.: US 2004/0173462 A1
(43) Pub. Date: Sep. 9, 2004

(54) Method to fabricate and stimulate an electrode to evolve heat with increased electrode power density

(76) Inventors: Dennis G. Letts, Austin, TX (US); Dennis J. Cravens, Cloudcroft, NM (US)

Correspondence Address: Dennis G. Letts, 12015 Ladrido Lane, Austin, TX, 78727, US

(21) Appl. No.: 10/382,778

(22) Filed: Mar. 6, 2003

(51) Int. Cl. H01M 4/02; C25B 1/02

(52) U.S. Cl. 205/92; 205/50; 205/57

(57) ABSTRACT

An electrode fabrication method, electrolytic cell and laser stimulation system for producing heat and elevated electrode power densities in a water-based liquid electrolyte. The electrode fabrication process involves using a Hydrogen absorbing metal that will form a hydride, cold working said metal, etching said metal, polishing said metal, ultrasonically cleaning said metal and annealing said metal. The electrolytic cell of the system has a pair of external magnets adjacent to the cell providing a magnetic field across the face of the cathode. The electrolytic cell also has a secondary anode of Gold capable of providing Gold ions to plate over to the cathode during the course of electrolysis. The system also has a laser under computer control capable of tuning the laser to specific wavelengths capable of triggering heat evolution and elevated electrode power densities.

### BACKGROUND

1. Field of Invention

This invention relates generally to the fabrication of metal electrodes capable of forming a hydride with a non-hydride metal overlayer and accompanying method to initiate the evolution of useful heat and increased power density of the hydrided electrode.

2. Description of Prior Art

Patterson teaches in U.S. Pat. No. 5,635,038 that multiple layers of metals used to fabricate electrodes are useful in the production of heat in electrolytic cells.

Patterson also teaches in U.S. Pat. No. 5,318,675 that Palladium can form a heat-producing hydride when used as a cathode in the electrolysis of heavy water.

The methods taught in the Patterson patents do not provide a triggering method to commence the evolution of heat on demand and in practice the evolution of useful heat was difficult to initiate and verify.

It is commonly known that Hydrogen and other types of fuel cells use a similar form of electrolysis as taught in the Patterson patents; the most potent fuel cells available today have a power density of less than 1 Waft per square centimeter of electrode.

Thus, the Patterson patents are lacking a triggering mechanism to initiate heat evolution and existing fuel cell technology is lacking truly high density electrodes. The present invention resolves both of these issues.

### SUMMARY INCLUDING OBJECTS AND ADVANTAGES

Summary: This invention teaches methods to fabricate an electrode that can be laser-stimulated to evolve useful heat on demand at a power density in excess of 10 watts per square centimeter of electrode. This represents a marked improvement over the Patterson patents and has great potential utility in the fuel cell industry.

### OBJECTS AND ADVANTAGES

This invention is directed to the fabrication and subsequent laser stimulation of a hydride-forming electrode using a multi-step protocol. This protocol and subsequent laser stimulation, results in an electrode that will evolve useful heat during electrolysis at a greatly increased power density.

### BRIEF DESCRIPTION OF THE DRAWINGS

FIG. 1 is a schematic view of the current invention in a closed electrolytic cell with external magnets on each side of the cell.

FIG. 2 is a graph showing the thermal response of an electrode fabricated by the methods of this invention after being irradiated by two laser pointers with a combined power output of 2 milliwatts.

FIG. 3 is an optical spectrum of laser pointer no. 1 used in tandem with laser pointer No. 2 to produce the graph shown in FIG. 2.

FIG. 4 is an optical spectrum of laser pointer no. 2 used in tandem with laser pointer no. 1 to produce the graph shown in FIG. 2.

FIG. 5 is a graph of the thermal response of an electrode fabricated and irradiated according to the methods of this invention but with Lexan placed in the laser beam.

FIG. 6 is a graph of the thermal response of an electrode fabricated and irradiated according to the methods of this invention but with a ½ wave retarder in the laser beam to change its polarization.

FIG. 7 is a graph of another electrode fabricated and irradiated by a laser diode tuned according to the methods of this invention.

FIG. 8 is a graph of another electrode fabricated and irradiated by a laser diode tuned according to the methods of this invention.

FIG. 9 is a graphic showing how Hydrogen is localized in the crystal structure of a Palladium electrode.

FIG. 10 is a list of constants and parameters used to determine the laser wavelength required to couple with hydrogen on the surface of an electrode.

FIG. 11 is a list showing the computation of the laser wavelength that will couple to hydrogen localized on the surface of an electrode.

FIG. 12 is a list showing the general protocol used to fabricate an electrode that will evolve heat when stimulated by a laser.

FIG. 13 is an article reporting that the most potent fuel cells today have a power density of less than 1 Waft per square centimeter.

### REFERENCE NUMERALS

1 Inert lid

2 O-ring seal

3 Catalyst to recombine gases within electrolytic cell

4 Transparent electrolytic cell containing electrolyte

5 Temperature sensors in an inert sheath

6 Magnets

7 Positive electrode

8 Negative electrode

9 Secondary positive electrode of a non-hydriding metal

10 Laser beam

11 Laser mount with power and temperature control circuitry

### PREFERRED EMBODIMENT—DESCRIPTION

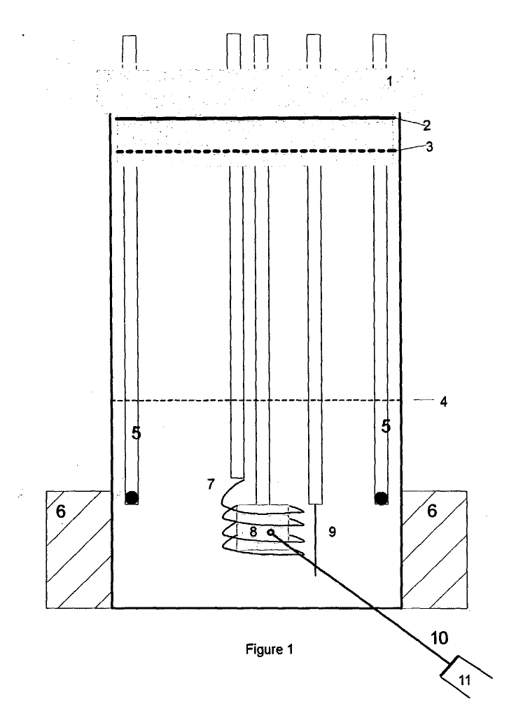

Referring now to the drawings and particularly to FIG. 1, a system embodying concepts of the invention is shown generally. This system is comprised of an electrolytic cell containing an electrolyte(4) sufficient to cover the electrodes(7,8,9). The cell is sealed by an inert lid(1) using an o-ring seal(2). Gases are recombined within the cell by the action of a catalyst imbedded in a groove cut in the lid(3).

Electrolysis is carried out in heavy water with the addition of acids or salts in a concentration sufficient to reach a minimum current density of 250 milliamps per square centimeter of negative electrode(8) surface area. After the negative electrode(8) has undergone electrolysis for at least 24 hours, Gold is overplated onto the negative electrode(8) by using a secondary positive electrode containing Gold(9). The primary positive electrode(anode) is Platinum(7). A laser beam(10) is directed onto the surface of the negative electrode(8) and focused to a narrow spot. The wavelength of the laser is tuned to a predetermined wavelength that is partially determined by the negative electrode(cathode) temperature. Laser power need not but may exceed 30 mw. Within a few minutes heat is evolved at the irradiated site with a power density many times greater than the most potent fuel cells available today.

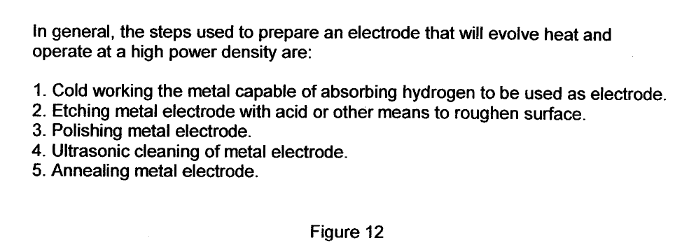

The negative electrode(8) is formed of a metal capable of absorbing Hydrogen and is processed in a series of steps involving cold-working, polishing and annealing as indicated in FIG. 12. This process is known to increase grain size and introduce dislocations to the lattice structure.

The thermal response of the cathode is measured using two thermistors(5) and compared to the ambient temperature. Two external magnets(6) provide a magnetic field across the cathode surface. A laser(11) capable of being tuned to specific wavelengths provides a highly focused beam(10) capable of being directed to various parts of the cathode(8).

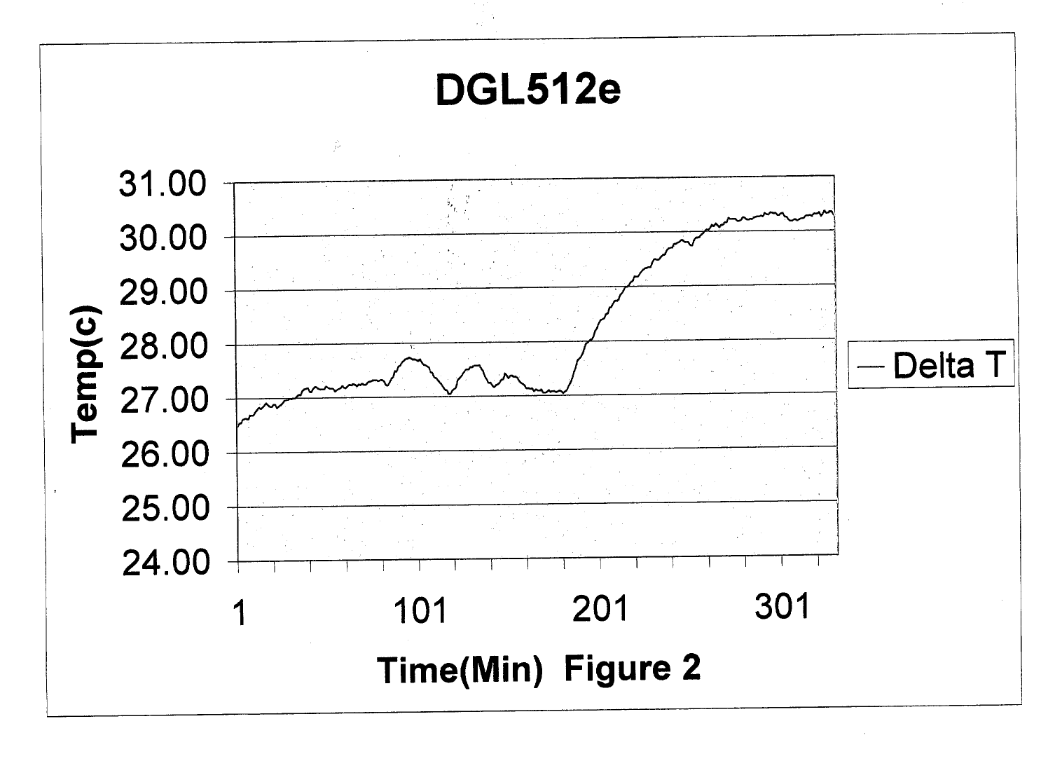

When the laser beam is tuned according to the methods of this invention and when it impinges upon a cathode fabricated according to the methods of this invention, heat evolves at the site of the laser irradiation as evidenced by the graph shown in FIG. 2.

### PREFERRED EMBODIMENT—OPERATION

The electrolytic cell containing electrolyte(4) suffcient to cover the electrodes(7,8,9) is shown in FIG. 1. The preferred electrolyte is LIOD at a concentration of 1M. The D2O was obtained from Spectrum Chemical Company, stock no. D1222, lot RG1260. Lithium was obtained from Aldrich Chemical, stock no.26,597-7, lot 07410 kz. Typically 75 grams of LIOD is sufficient to cover the electrodes(7,8,9) and support electrolysis between the anode(7) and cathode(8). The preferred material for the lid(1) is Teflon and the o-ring seal(2) is typically Buna. The preferred catalyst imbedded in a groove cut in the lid(3) is typically 0.5% Platinum on 1/8 inch Alumina pellets, reduced and was obtained from Alfa Aesar, stock no. 89106, lot J14M16.

Electrolysis is accomplished by connecting the cathode(8) to the negative terminal and the anode(7) to a positive terminal of a DC power supply capable of providing up to 2 amperes at 10 volts. Power supply used by applicants was a Hewlett-Packard E3632E. The secondary anode of Gold(9) is also connected to the positive terminal of the DC power supply when Gold is to be plated onto the cathode(8). Jewelers Gold of 0.999 purity from AMC Metallurgical of Austin, Tex. was used as the secondary anode.

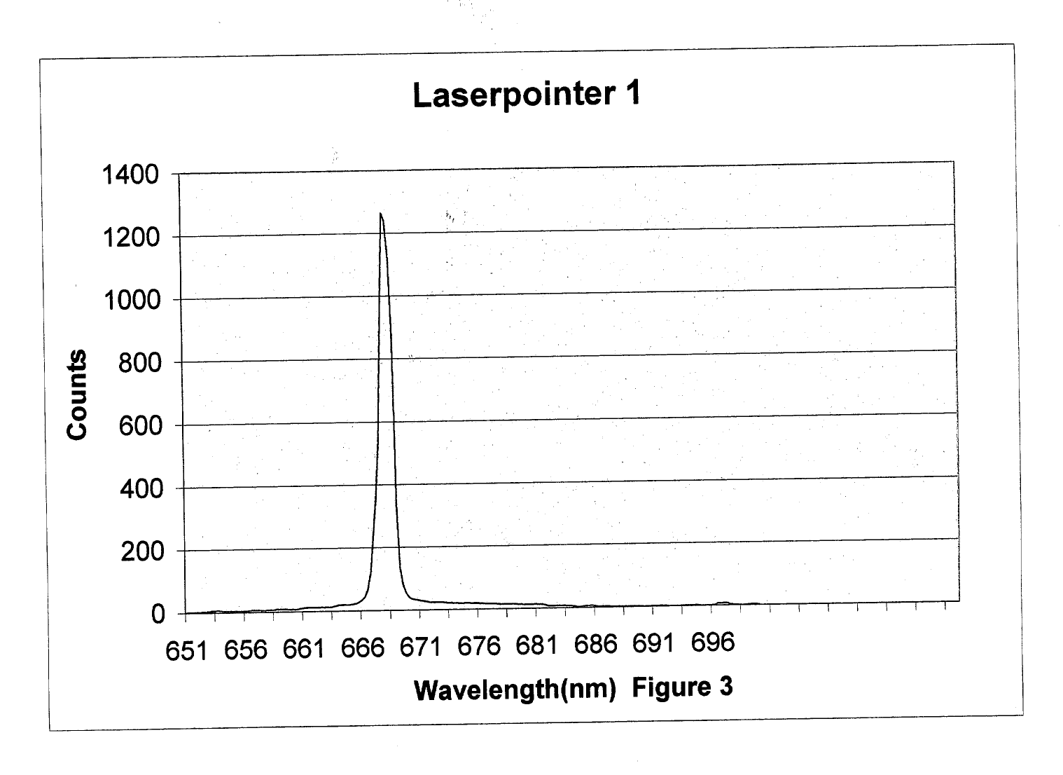

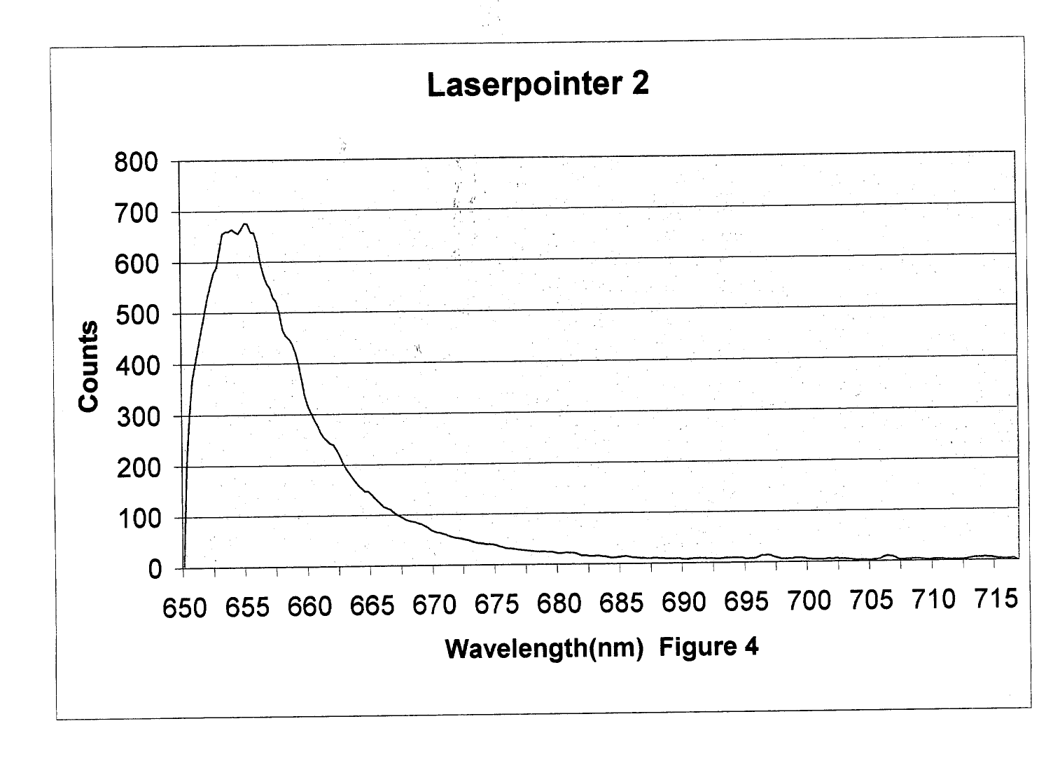

The tunable laser(11) is typically controlled thermally by a peltier device; the laser can also be focused to a small diameter-typically 2 mm in diameter. The preferred instrument is an Optima laser mount with power and temperature controllers, purchased from Optima Precision Electronics of West Lynn, Oreg. An off-the-shelf diode can usually be tuned over a range of 5 nm by changing the diode temperature. Laser tuning is typically monitored by a Stellamet optical spectrum analyzer, model EPP2000, the output of which is shown in FIG. 3 and FIG. 4.

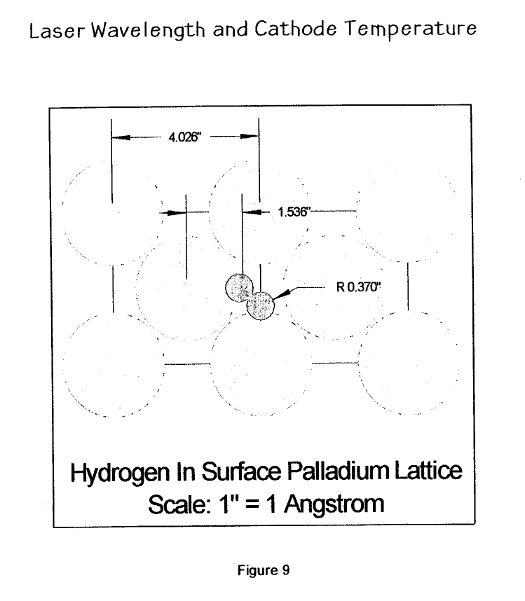

Laser tuning is controlled by a computer and is determined by the size of the cavity provided by the cathodic material after it has been loaded with Hydrogen and thermally expanded by the heat of electrolysis. Hydrogen is localized in these cavities on the surface of the cathode as depicted in FIG. 9 and can be stimulated by a laser whose photon energy is resonant with one of the energy levels allowed by quantum mechanics.

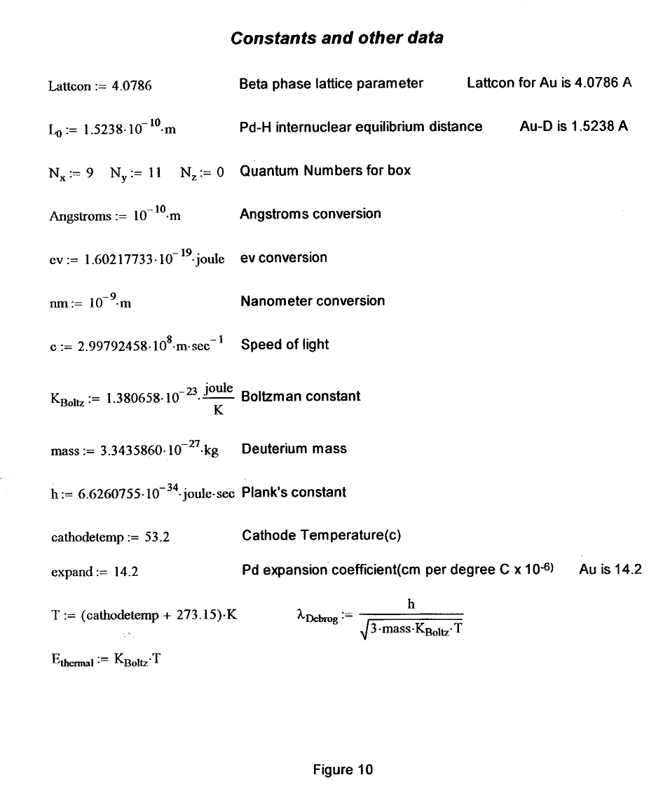

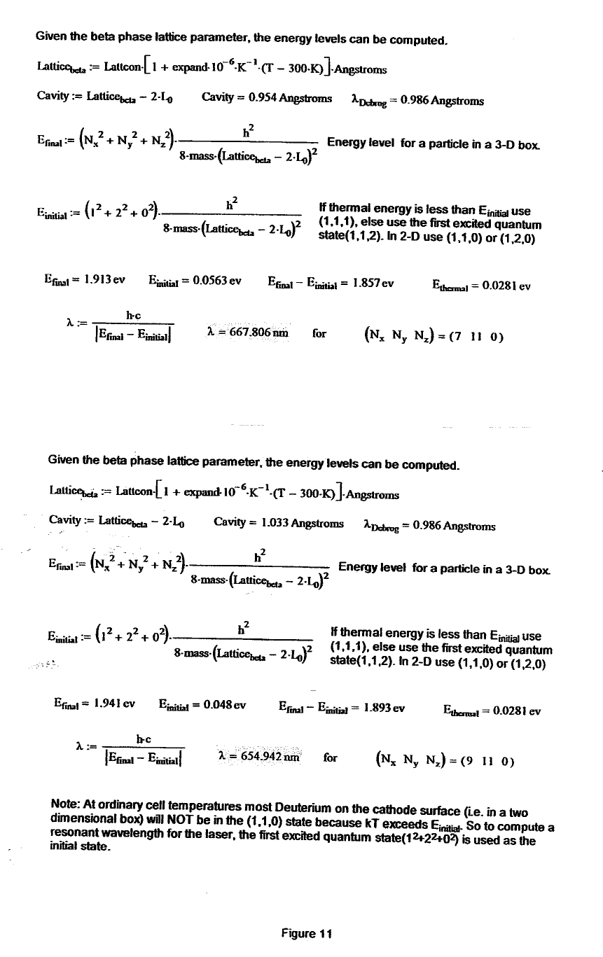

The constants and other data used in making the computation are shown in FIG. 10 and the actual computation is shown in FIG. 11. This same data and computational methods are used by a computer to tune the laser in real time.

Cell temperature taken near the cathode serves as an estimate for lattice temperature, which, with the crystal lattice parameter, determines cavity size. The cavity size determines the quantum energy levels and the energy levels determine the laser wavelength.

In addition to providing a laser tuning method, this invention provides a protocol to fabricate electrodes that will absorb hydrogen and evolve heat at an increased power density when irradiated by a laser wavelength determined as shown in FIGS. 10 & 11. The preferred cathode material is Palladium foil from Alfa Aesar stock no. 11514.

The preferred fabrication method is as follows:

1. Cut a billet of electrode material (typically Palladium) 10 mm×10 mm×0.5 mm

2. Polish to bright using a dremel tool with a fiber brush and Nicksand(AI. Oxide)

3. Rinse in tap water

4. Heat in furnace to 750 C for 3 hours slowly cool to ambient.

5. Etch for 2 minutes in Aqua Regia at room temperature.

6. Re-polish with Dremel tool using a metal brush.

7. Re-polish with Dremel tool using a fiber brush until bright using Nicksand.

8. Ultrasonically clean for 5 minutes using either distilled water alone or with cleaner.

9. Anneal for 2.5 hours at 850 C.

10. Polish with Dremel tool using metal brush then fiber brush and Nicksand.

11. Ultrasonically clean 5 minutes using an oxide remover; rinse well in distilled H2O.

12. Cold roll to 0.25 mm thickness, or to a 50% thickness reduction.

13. Re-polish with a Dremel tool using a metal brush then a fiber brush.

14. Ultrasonically clean 5 minutes with Oxide remover.

15. Anneal for 2.5 hours at 850 C.

16. Etch with Aqua Regia for 2 minutes at room temperature.

17. Rinse in distilled water; cathode is ready for electrolysis.

The cathode(8) is then cut to a typical size of 5 mm×7 mm and placed inside the anode structure(7), typically a coil of 0.5 mm diameter Platinum wire of four turns over the cathode length. The Pt wire was obtained from Alfa Aesar, stock no. 10286. The cathode(8) is then charged with Hydrogen for at least 24 hours at less than 50 Milliamperes per square centimeter of cathode surface area exposed to the electrolyte. Current is then increased to at least 500 Milliamperes per square centimeter for high-current loading for at least 24 hours. At the end of this period, Gold is overplated onto the cathode(8) by connecting the secondary anode(9) to the positive terminal of the DC power supply. The secondary anode remains connected for at least 10 minutes while electrolysis continues at high current density. Gold plating out of solution continues even after the secondary anode is disconnected. The minimum cell operating temperature is 40 C and 55 C is considered optimum. The minimum overall time for this operation is 48 hours while 120 hours is considered typical. The cathode(8) will begin to turn dark as gold is plated onto its surface, indicating that the cathode is ready for laser irradiation.

### Experimental Results

According to the methods shown in FIGS. 10 and 11, there are many laser wavelengths that can couple to the Hydrogen on the surface of the cathode but not many in the visible range. There are only five diode ranges in the visible laser range: 635 nm, 650 nm, 660 nm, 670 nm and 680 nm. Of these, four have been tested and have triggered heat evolution at the site of irradiation: 650 nm, 660 nm, 670 nm and 680 nm. The 650 nm diode was obtained from Lasermate, Inc. stock no. LD65020G, the 660 nm diode was obtained from Mitsubishi, stock no. 1016R, the 670 nm diode was a laser pointer from Radio Shack, the 680 nm diode was obtained from Mitsubishi, stock no. 1012R.

FIG. 2 shows heat evolution triggered by two 1 mw laser pointers of fixed wavelength. Experiment DGL512e was an early experiment operating with a cell temperature of 53.2 C. The two laser pointers were directed onto the cathode of experiment DGL512e and the graph shown in FIG. 2 resulted. Individual laser irradiation began near point 85 and continued to point 150, resulting in only three small excursions in cathode temperature. At point 185 both lasers were directed onto the lower right corner of the cathode and a large evolution of heat occurred, causing the temperature of 75 grams of LIOD to increase by more than three degrees C.

The laser pointers were subsequently analyzed in an optical analyzer as shown in FIG. 3 and FIG. 4; laserpointer 1 operated at a peak of 668 nm compared to a resonant wavelength of 667.81 nm. Laser pointer 2 operated at a peak of 655 nm compared to a resonant wavelength of 654.94 nm. In short, the laser pointers operated exactly on resonance with Hydrogen on the cathode surface and a large amount of heat was evolved.

Other experiments were performed with tunable lasers at or near the diode ranges mentioned above. One such experiment was DGL564e which demonstrated that Lexan can inhibit heat evolution when placed in the path of the laser beam. Referring to FIG. 5, heat was evolving following a tuned laser stimulation at 662.83 nm until point 134 where a small square of Lexan was placed in the laser beam path. There was an immediate decline in heat evolution.

The power of the laser was measured with an Ophir power meter on both sides of the Lexan. The Lexan reduced the 30 mw laser beam by about 1 mw. Plastic is known to change the polarization of light so a ½ wave retarder was placed in the laser beam of the next experiment.

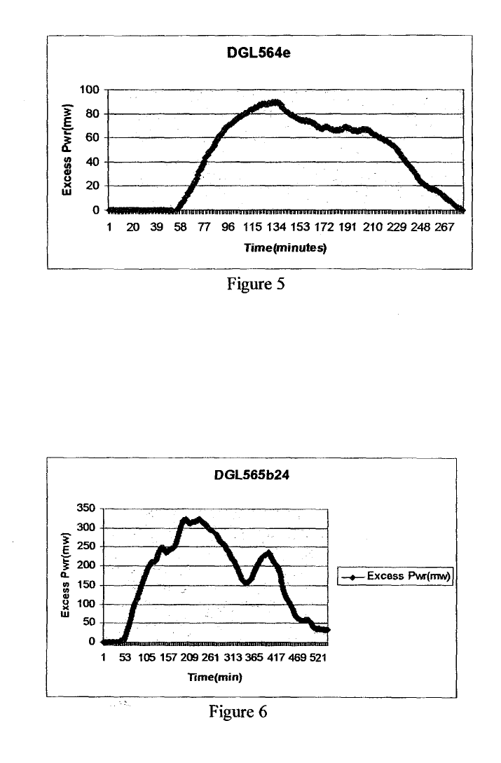

The polarization results of experiment DGL565b24 are shown in FIG. 6; the electrolytic cell was configured as shown in FIG. 1. The ½ wave retarder was marked in degrees, making it possible to rotate the polarization with respect to the magnet field across the cathode(8) created by the external magnets(6). The 1/2 wave retarder was obtained from Casix, Inc. of Chatsworth, Calif. The laser was tuned to 661.09 at first and it increased slightly as the cathode warmed due to the influence of the laser. The cathode evolved heat at the rate of 320 milliwatts until point 230 where the ½ wave retarder rotated the polarization of the beam so that the E field of the beam was approximately parallel to the magnetic field across the cathode. When this happened the cathode heat evolution declined sharply and returned toward baseline. At point 335 ½ wave retarder was removed from the laser beam and the heat evolution increased. At point 400 the laser was turned off and the heat evolution declined slowly to zero.

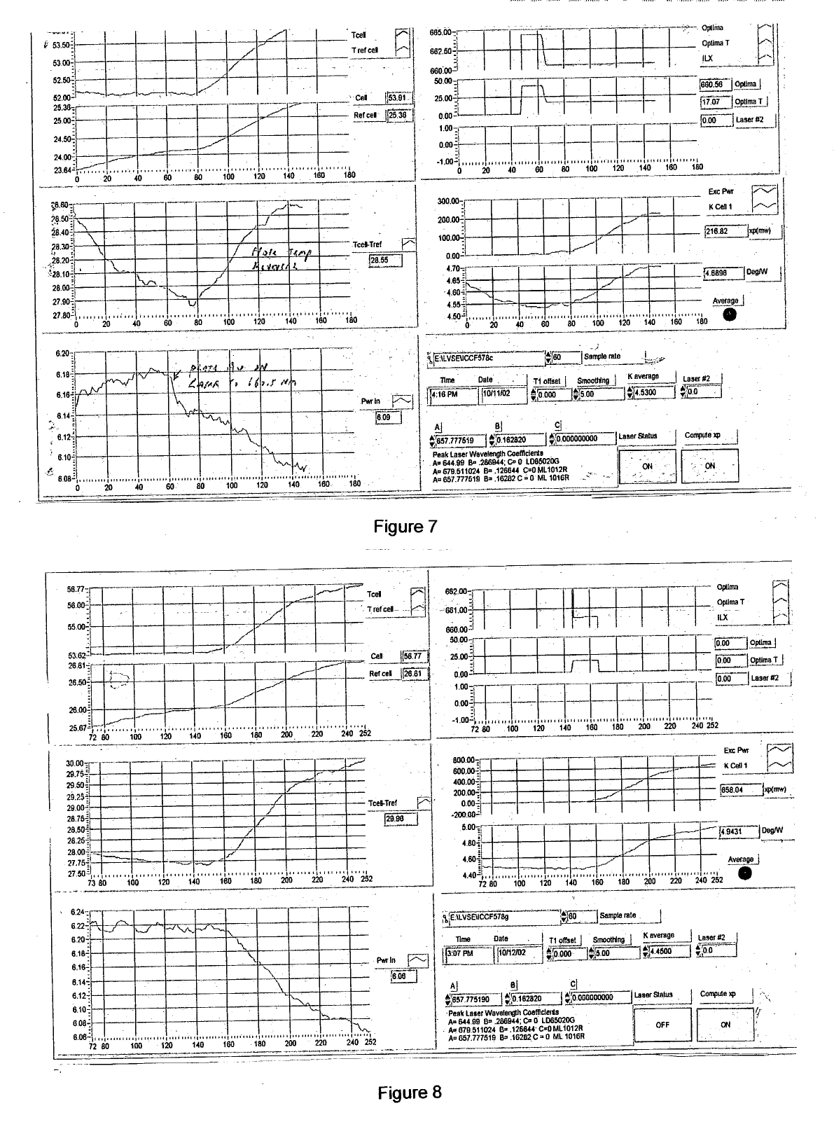

Experiments continued as shown in FIG. 7 and FIG. 8 which are images from the computer monitor; the electrolytic cell was configured as in FIG. 1. The test shown in FIG. 7 as DGL578c was run on Oct. 11, 2002. At point 65 the laser was re-tuned from 664 nm down to 660.56 nm and by point 78 heat evolution began. On this first run only a small amount of Gold had been plated on the cathode. Heat evolved at a maximum rate of 200 mw. Laser power was 30 mw.

FIG. 8 shows the results from experiment DGL578g performed on Oct. 12, 2002. The laser was turned on to 660.5 nm at point 145. By point 150 cathode temperature began to increase to produce heat at a maximum of 660 mw from a laser stimulation of 30 mw. The cathode used in these two experiments was prepared in accordance with FIG. 12.

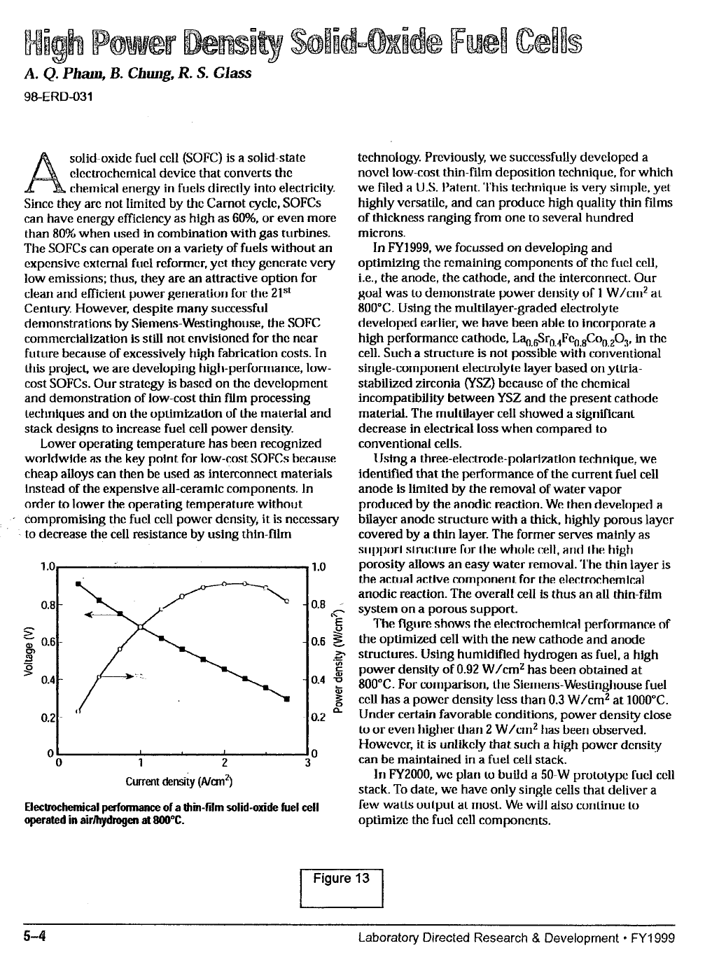

Cathode 578 evolved heat from the laser-irradiated area with a power density of approximately 20 wafts per square centimeter (0.6 watts/0.03 square cm); this is 20 times greater than the high density solid oxide fuel cells referred to in FIG. 13.

### CONCLUSIONS, RAMIFICATIONS, AND SCOPE

Accordingly, it can be seen that a cathode prepared and operated according to the protocol taught by this invention and stimulated by a laser of a pre-determined wavelength, also taught by this invention, will evolve useful heat at a power density much greater than any method in use today.

Although the description above contains many specificities, these should not be construed as limiting the scope of the invention but as merely providing illustrations of some of the presently preferred embodiments of this invention. Various other embodiments and ramifications are possible within its scope. For example, creating the hydride could occur in the gas phase instead of electrolytically, more powerful lasers could be used or lasers of very long or short wavelengths could be used. Multiple lasers could be used as was done in DGL512e with positive results. Materials other than Palladium could be processed in a similar manner, loaded with Hydrogen and irradiated with various lasers tuned to resonate with Hydrogen in the surface cavity of the new material. Further, it appears feasible that quantum wells of one, two or three dimensions could also be created using the techniques of Molecular Beam Epitaxy and used to trap Hydrogen therein. The size of the quantum wells would be known and would lead to well-defined resonant laser wavelengths. Indeed, in the gas phase, ceramic material might even be loaded with Hydrogen and stimulated with a laser wavelength appropriate for Hydrogen on the surface of a ceramic.

More powerful external magnets and/or electric fields could also be applied to provide for alignment of the Hydrogen on the cathode surface; electromagnetic waves at radio or microwave frequencies could also be applied. Surface waves and other waves known to solid state physics could also, in theory, be applied to the concepts of this invention.

Thus the scope of the invention should be determined by the appended claims and their legal equivalents, rather than by the examples given.

What is claimed is:

1. The use of an intense light beam to increase the thermal output of an electrolytic cell, where the light is incident upon one electrode.

2. The use of a laser beam as an intense light beam as claimed in 1.

3. The modification of the Hydrogen loading into a metal by the use of light.

4. The use of a light beam of a predefined wavelength in claim 2, chosen to alter the thermal energy release of an electrode.

5. The modification of the thermal release from a Hydrogen-containing metal electrode in an electrolytic cell by the incidence of light at a predetermined wavelength on said electrode and the application of a magnetic field in the volume containing said electrode.

6. The modification of thermal release as in claim 5, where the light is linearly polarized and the direction of polarization is chosen by its relative direction to a magnetic field.

7. The use of a combination of preparation methods for a metal electrode in an electrolytic cell, where said preparation combines the use of cold working the metal to be used as said electrode, etching said metal electrode, polishing said metal electrode, ultrasonic cleaning of said metal electrode, annealing said metal electrode.
